(19) United States
(12) Patent Application Publication
(10) Pub. No.: US 2012/0329361 A1
(43) Pub. Date: Dec. 27, 2012

(54) DETACHABLE GARMENT OR ACCESSORY FOR A TOY

(75) Inventor: Mark Buckley, London (GB)

(73) Assignee: Fuse London Ltd.

(21) Appl. No.: 13/490,202

(22) Filed: Jun. 6, 2012

(30) Foreign Application Priority Data
Jun. 27, 2011 (GB) 1110803.2
Feb. 22, 2012 (GB) 1202995.5

(51) Int. Cl. A63H 3/36; B23P 19/04

(52) U.S. Cl. 446/268; 29/428

(57) ABSTRACT

A detachable garment or accessory for a toy. The garment or accessory includes at least a first front part and a second rear part movable relative to each other via pivot or hinge means on or associated with the parts between an open position, wherein the garment or accessory can be attached to or removed from at least part of the toy, and a closed position, wherein the garment or accessory can be secured to the toy. Each part includes a top edge, a base edge and lateral edges. The pivot or hinge provided between one or more of the lateral edges of the front and rear parts allow at least a portion of the lateral edges of the parts to be separated to form the open position and moved towards each other to form the closed position.

This invention relates to a detachable garment or accessory for a toy and a method of use thereof.

Although the following description refers almost exclusively to a detachable garment and/or accessory for a female doll having the appearance of a human, it will be appreciated by persons skilled in the art that the doll can take any suitable form of a toy to which one or more items can be detachably attached. For example, the toy can be in the form of an animal, imaginary character, monster and/or the like.

It is known to provide a toy, such as a doll, with detachable clothing to improve the aesthetic appearance of the doll to a child and to provide improved interaction of the child with the doll. For example, US2010/0041301 discloses clip fashion for a doll including an item of clothing having two sections. Each section has a front portion and a back portion. The back portions are joined together by a spring biased pivotable clasp mechanism. Compressing and releasing the clasp mechanism at the rear of the clothing causes lateral edges of the front portion to separate and close about the lateral edges respectively. This in turn allows the item of clothing to be attached to and removed from the doll via the rear of the doll. Problems associated with this type of detachable clothing are that the clasp mechanism typically limits the aesthetic appearance of the back of the clothing to having wings and thereby reduces the realism of the doll to having a human appearance. The type of detachable clothing is also typically limited to engaging with the body portion only of the doll. In addition, the child has to directly actuate the clasp mechanism in order to move the clothing between open and closed positions, thereby limiting the number of possible applications of the detachable clothing with the doll and also reducing the realism to a user of the doll being able to dress itself.

It is therefore an aim of the present invention to provide a detachable garment or accessory for a doll or toy that overcomes the abovementioned problems.

It is a further aim of the present invention to provide a doll or toy with a detachable garment or accessory.

It is a yet further aim of the present invention to provide a method of using a detachable garment or accessory for a doll or toy.

It is a yet further aim of the present invention to provide a method of using a doll, or toy with a detachable garment or accessory.

According to a first aspect of the present invention there is provided a detachable garment or accessory for a toy, said detachable garment or accessory including at least a first front part and a second rear part pivotably or hingedly movable relative to each other via pivot or hinge means provided on or associated with the parts between an open position, wherein the garment or accessory can he attached to or removed from at least part of the toy, and a closed position, wherein the garment or accessory can be secured to the toy, characterised in that each of the at least first front part and second rear part include a top edge, a base edge and lateral edges, said pivot or hinge means provided between one or more of the lateral edges of said front and rear parts to allow at least a portion of the lateral edges of the parts to be separated to form the open position and moved towards each other to form the closed position.

Thus, the present invention allows a garment or accessory to be fitted to a toy via a pivot or hinge arrangement provided between or at the lateral edges of the front and rear garment or accessory parts to allow the front and rear garment parts to be moved between open and closed positions with respect to each other. This is in, contrast to the prior art arrangement which has the pivot or hinge arrangement at the rear of the clothing part so that only the front of the clothing part can be moved between open and closed positions.

The arrangement of the present invention has the advantage that the toy or doll can be inserted through an opening defined between the top and/or base of the garment or accessory parts when in an open position, thereby increasing the ease with which the garment can be attached to and/or removed from the toy or doll. The solution removes the requirement of wings or a clasp mechanism to be provided at the rear of the garment as is the problem with the prior art. In addition, the hinge or pivot arrangement of the present invention is such that the toy or doll is moved in a direction substantially transverse to the pivot or hinge axis in attaching or detaching the garment from the toy or doll and the toy or doll can be moved through the pivot or hinge axis in attaching or detaching the garment from the toy or doll. This allows the garment to be attached to the toy or doll manually and/or in a wholly or at least partially automated manner, thereby providing the appearance of the toy or doll dressing itself which increases the realism of the toy or doll to a user, particularly if the user is a child. It increases the number of possible applications via which the garment or accessory can be used with the toy or doll. The pivot or hinge arrangement of the present invention can also allow more realistic garments to be provided for the toy or doll that arc not limited to attachment to a single part of the toy or doll body part only. For example, the garment or accessory of the present invention can be in the form of any or any combination of a dress, skirt, trousers, shirt, corset, bodice, tank top and/or the like, and particularly can be in the form of a garment with sleeve or leg members provided therein to be located around one or more arms or legs of a toy or doll respectively.

The at least first front part and/or second rear part could include a single or integral first part and/or second part and/or the at least first front part and/or second rear part could include two or more first parts and/or two or more rear parts.

Preferably the at least first front part and second rear part arc shaped so as to define a cavity therebetween when in the closed position. For example, the front and rear parts can be in the form of shell like members. The cavity is of such size and/or shape so as to allow at least part of the toy or doll to be located therebetween in use. The cavity defined between the parts is also preferably of such size and/or shape when the parts are in an open position so as to allow at least part of the toy or doll to be moved through the same without obstruction.

Preferably the shape of the cavity is substantially complementary to the shape of the part of the toy or doll to which the garment or accessory is to be attached to in use.

In one embodiment the pivot or hinge means is associated with, provided at, or between a single lateral edge of the front and rear parts. Preferably the single lateral edges of the front and rear parts arc abutting or adjacent each other. In an alternative embodiment the pivot or hinge means is provided between two and/or opposite lateral edges of each of the front and rear parts. In this latter embodiment the two pivot or hinge means are preferably provided a spaced distance apart on the lateral edges with the cavity or opening defined between the parts for the doll or toy located therebetween.

Preferably the pivotal axis of the pivot or hinge means on the opposite lateral edges of the front and rear parts are substantially aligned or parallel and further preferably are co-axial to each other.

Preferably the pivot or hinge means is associated with, provided at, adjacent to or towards a base or base edge or a top or top edge of the front and rear parts.

Preferably a user is required to apply a compressive force directly or indirectly to an outer surface of the front and/or rear garment or accessory parts at or adjacent the top or base with which the pivot or hinge means are associated in order to move the parts from a closed position to an open position in use. The edge or portion of the parts on which the compressive force is applied allows the opposite edge or portion to move from a closed position to an open position.

in one embodiment user actuation means or device arc provided on or associated with the front and/or rear parts to allow a user to move the parts from a closed position to an open position in use. In one example, the user actuation means includes one or more protruding portions and preferably two protruding portions. The protruding portion(s) preferably protrude outwardly from a surface or surfaces, edge or edges of the front and/or rear parts to allow a user to easily manipulate the same in use. The protruding portion or portions are moved towards each other and/or towards the toy or doll to actuate the same and move the parts to an open position.

Preferably the one or more protruding portions protrude or extend outwardly from a top or base portion or edge of the front and/or rear garment or accessory parts. Further preferably the protruding portions protrude or extend above or below the top or base of the top or base portion or edge respectively of the front and/or rear parts.

In one embodiment the one or more protruding portions are provided substantially centrally of the garment or accessory part on the front and/or rear thereof.

Preferably the one or more protruding portions are provided in such dimensions and/or location that the protruding portion does not obstruct movement of the doll or toy in use. For example, the protruding portion can be relatively thin so that one or more legs of the toy or doll can move without contact or obstruction from the protruding portion, the toy or doll can bend at the waist and/or other section thereof without contactor obstruction from the protruding portion and/or the like.

In a preferred embodiment the pivot or hinge means is associated with, provided at, adjacent to or towards the base portion or edge of the front and rear parts and the top edge or portion of the parts is moved between open and closed positions.

In one embodiment resilient biasing means are provided on or associated with the pivot or hinge means for biasing the front and/or rear parts from the open position to the closed position. A user is typically required to apply a force to or adjacent the pivot or hinge means against the resilient biasing means in order to move the front and rear parts to the open position.

The resilient biasing means can include any or any combination of a spring, torsion spring, sprung metal, elasticated member, rubber member and/or the like.

In one embodiment the resilient biasing means is in the form of a single spring or sprung clement that is provided at or adjacent substantially the entire perimeter of the garment or accessory parts adjacent the pivot or hinge means.

In one embodiment the pivot or hinge means includes protrusion means provided on one of the front and rear parts that is movable in a recess, channel, aperture, groove and/or the like provided on the other of the front and rear parts. The protrusion means can be in the form of a pin, arm and/or the like.

The protrusion means can be movably mounted in the recess, channel, aperture, groove and/or the like via pivoting, hingeing, rotating, sliding and/or the like.

Preferably the pivot or hinge axis or axes of the pivot or hinge means, about which the front and rear parts pivot, hinge or rotate in use, passes through or is located in the opening or cavity defined between the front and rear parts in either the closed or open positions.

In one embodiment the hinge or pivot axis of the hinge or pivot means is located substantially parallel to the base edge(s) and/or top edge(s) of the front and/or rear parts.

Preferably the hinge of pivot axis is substantially transverse to the lateral edges of the front and rear part on which the hinge or pivot means are provided on or associated with.

In one embodiment extension means or parts are provided which extend below or above an edge or portion of the front and/or rear garment or accessory parts. Preferably the hinge or pivot means or axis is provided on or associated with said extension means. Thus, in one embodiment, the hinge or pivot means or axis is provided above or below a base or top edge of the main front and/or rear of the garment or accessory parts. The extension means or parts can be integral with, attached or detachably attached to the front and/or rear parts.

Preferably the extension means are provided at or adjacent the lateral edges of the front and/or rear garment or accessory parts.

Preferably at least one opening, recess and/or aperture is defined in at least the front and/or rear parts to allow at least part of a toy or doll to protrude therethrough when the garment or accessory part is in a closed position on the toy or doll. For example the at least one opening, recess and/or aperture can define a neck hole, a leg hole, arm hole and/or the like for the toy or doll.

In one embodiment the at least one opening, recess and/or aperture is increased in size on moving of the front and rear parts from the closed position to the open position. At least a part of the toy or doll is arranged to pass through the at least opening, recess and/or aperture when the toy or doll is secured to the garment or accessory.

Preferably at least part of the toy or doll passes through an opening, recess and/or aperture defined between the garment or accessory parts when in an open position and is moved through or towards a virtual line corresponding to the pivot or hinge axis of rotation of the parts in order to secure the garment or accessory parts to the toy or doll.

The cavity between the garment or accessory parts where the pivot or hinge axis is located is typically unobstructed when the parts are in an open position so as to allow at least part of the toy or doll to pass therethrough.

In the embodiment where there are hinge or pivot means provided adjacent both opposite lateral edges of the garment or accessory parts, the pivot or hinge axes arc substantially co-axial to each other and a space is defined between the same so that at least part of the toy or doll can pass between the hinge or pivot means and through the co-axis.

Preferably the at least one opening, recess and/or aperture is in communication or is joined to the cavity defined between the front and rear parts of the garment or accessory.

In one embodiment a plurality of openings, apertures and/or recesses are defined between the at least front and rear parts to allow a plurality of parts of the toy or doll to protrude therethrough in use.

In a preferred embodiment an opening, aperture and/or recess is defined between at least the base edges and the top edges of the garment or accessory to allow parts of the toy or doll to be located therein or protrude therethrough when the parts are in the closed position.

The toy can be in the form of a doll, teddy bear, human like character, animal, monster, imaginary character and/or the like.

In a preferred embodiment the toy is in the form of a human like doll having a head, a body or trunk, and preferably at least two arms and two legs.

In a preferred embodiment the garment or accessory is located on the toy or doll by inserting the base or legs of the toy or doll through an opening defined between the top edges of the garment or accessory parts such that the base or legs of the toy or doll moves through the hinge of pivot axis of the garment or accessory located adjacent a base edge of the garment or accessory parts. It will be appreciated that the toy or doll could be inserted via the base edge of the garment or accessory part and the hinge or pivot axis of the parts could be located adjacent at or adjacent a top edge of the parts.

The garment or accessory can include any or any combination of a dress, skirt, shirt, trousers, jumper, blouse, coat, cardigan, jacket, scarf, armour and/or the like.

The garment or accessory can be provided in any suitable size, shape and/or design. Preferably the size and/or shape of the interior surface of the garment or accessory is substantially complementary or slightly larger to the size and/or shape of the exterior surface of the part of the toy to which the garment or accessory is to be attached to in use, thereby allowing the garment or accessory to form a snug or secure fit to the doll in use when in the closed position.

The garment or accessory can be formed from any or any combination of suitable material, such as metal, plastic, wood, fabric, rubber and/or the like.

In one embodiment the front and/or rear garment or accessory parts that are movable between the open and closed positions can have material or fabric attached to or associated with the same. Preferably the material or fabric attached to or associated with the garment or accessory part is substantially flexible or is more flexible than the garment or accessory parts.

In one embodiment the front and/or garment or accessory parts are substantially rigid in form.

According to a second aspect of the present invention there is provided a method of fitting a detachable garment or accessory to a toy, said method including the steps of pivotably or hingedly moving at least a first front part and a second rear part of the garment or accessory relative to each other via pivot or hinge means provided on or associated with the parts between an open position, wherein the garment or accessory can be attached to or removed from at least part of the toy, and a closed position, wherein the garment or accessory can be secured to the toy, characterised in that each of the at least first front part and second rear part include a top edge, a base edge and lateral edges, said pivot or hinge means provided between one or more of the lateral edges of said front and rear parts to allow at least a portion of the lateral edges of the parts to be separated, to form the open position and moved towards each other to form the closed position.

Preferably a user applies the garment or accessory to the toy manually or the garment or accessory is applied to the toy via a mechanical and/or automated means or device.

According to a third aspect of the present invention there is provided a toy including a detachable garment or accessory.

According to an aspect of the present invention there is provided a toy with a detachable garment or accessory, said detachable garment or accessory including a first part and at least a second part pivotably or hingedly movable relative to each other via pivot or hinge means between an open position, wherein at least part of the garment or accessory can be attached to or removed from at least part of the toy, and a closed position, wherein the garment or accessory can be secured to the toy, characterised in that at least part of the toy is movable through the pivotal or hinge axis of the pivot or hinge means when the parts are in an open position to allow the garment or accessory-to be secured to the toy in the closed position.

According to a fourth aspect of the present invention there is provided a method of using a toy with a detachable garment or accessory.

Embodiments of the present invention will now be described with reference to the accompanying figures, wherein:

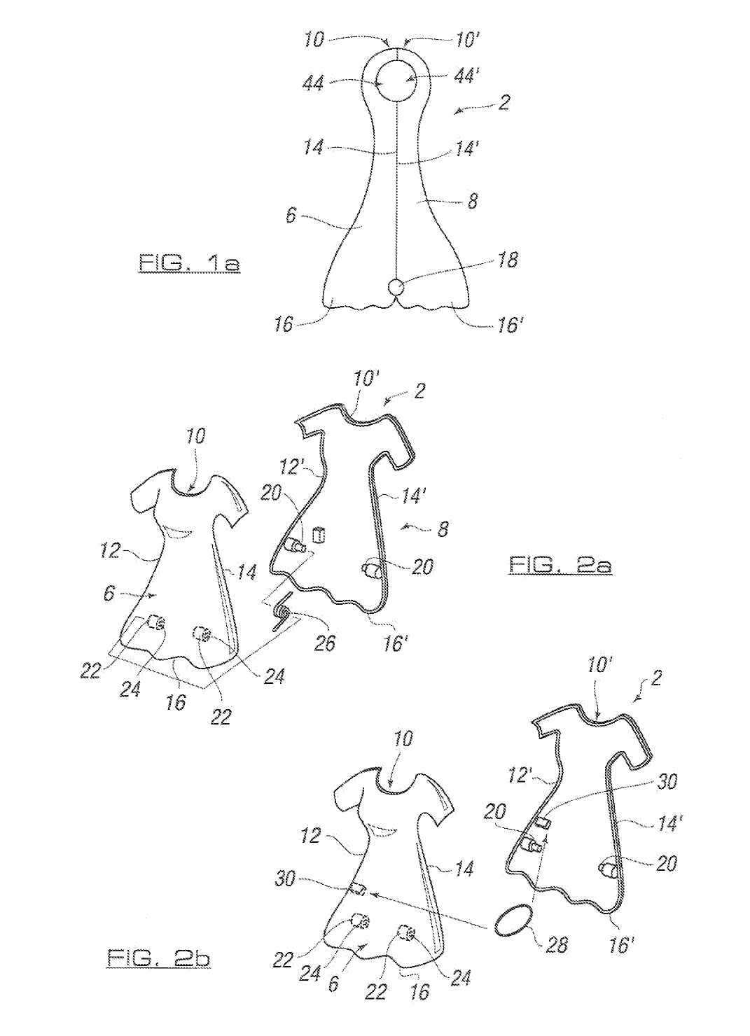

FIGS. 1a and 1b show a side view of a garment in the form of a dress in a closed position and in an open position respectively;

FIGS. 2a and 2b show an exploded perspective view of the garment in FIGS. 1a and 1b using two different resilient biasing means;

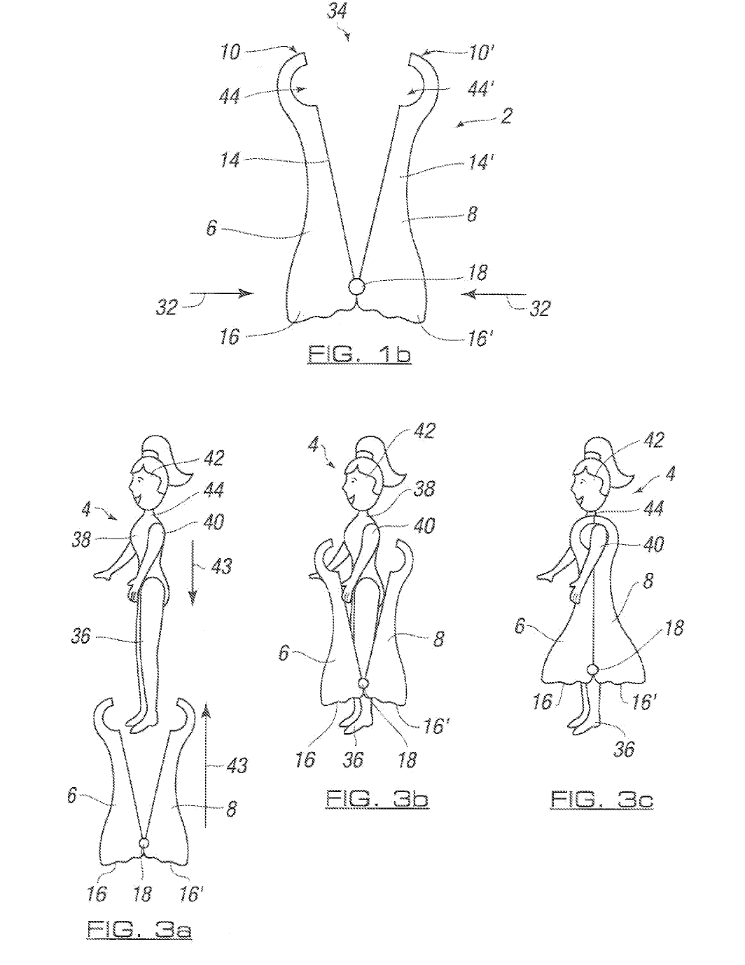

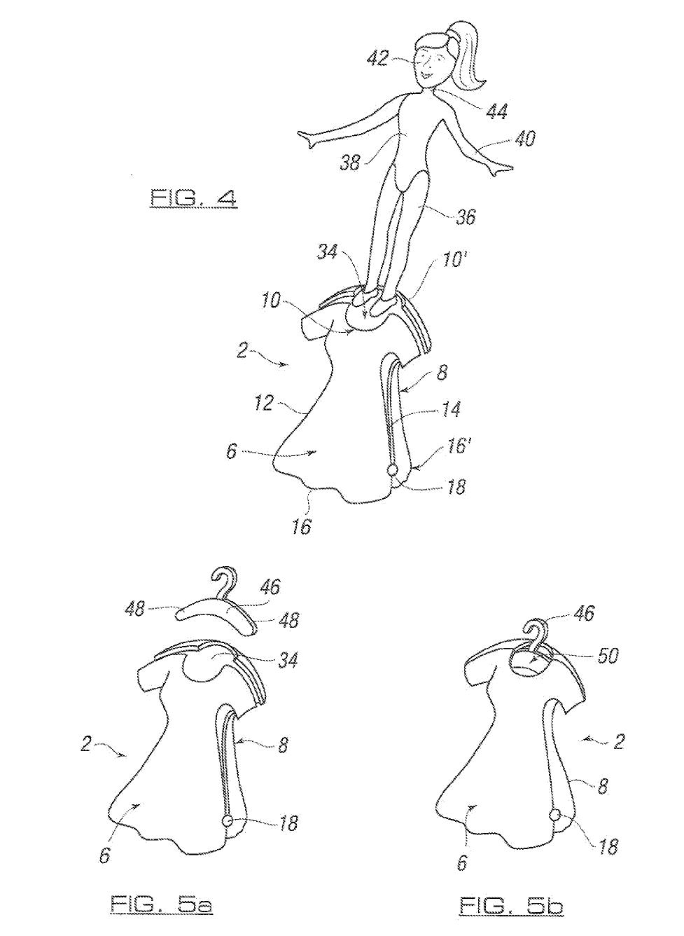

FIGS. 3a-3c show the stages involved in fitting the garment in FIGS. 1a and 1b to a toy doll when viewed from the side;

FIG. 4 shows an initial stage in fitting the garment in FIGS. 1a and 1b to a toy doll when viewed from the front;

FIGS. 5a and 5b show the garment in FIGS. 1a and 1b located on a hanger in an open position and closed position respectively;

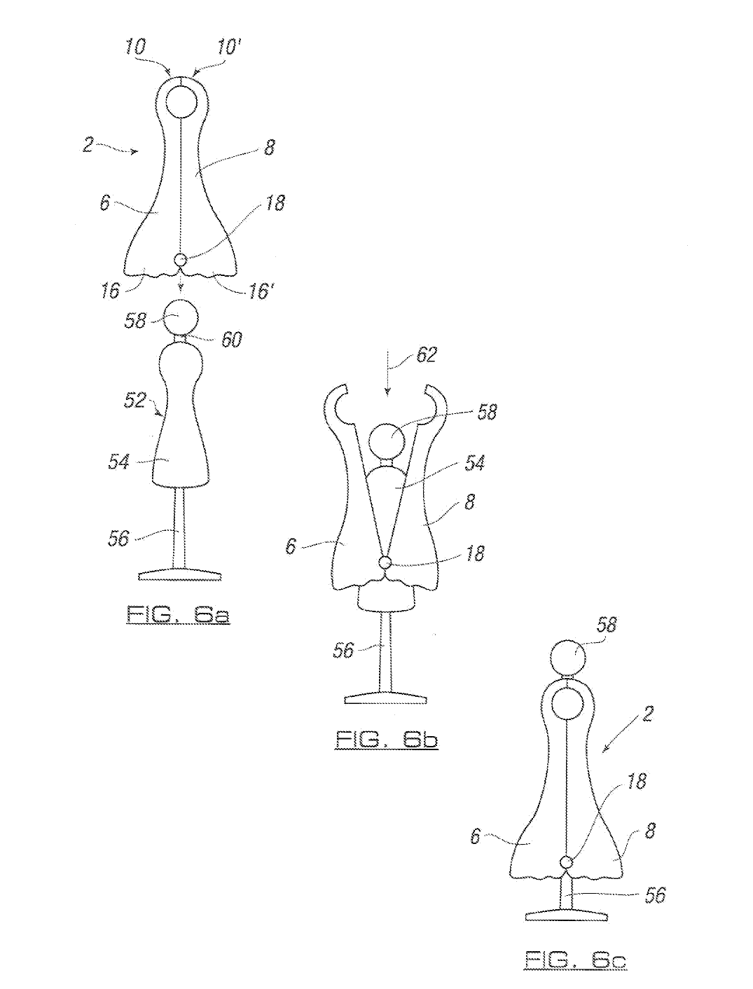

FIGS. 6a-6c show the stages involved in fitting the garment in FIGS. 1a and 1b to a stand or mannequin;

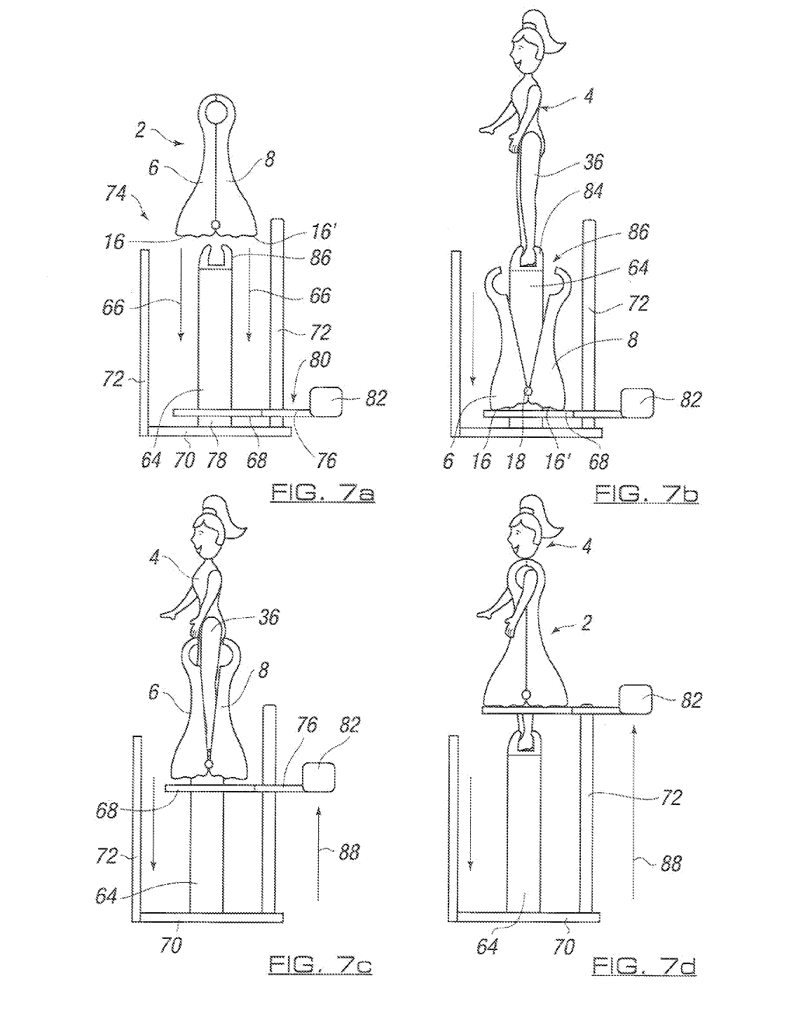

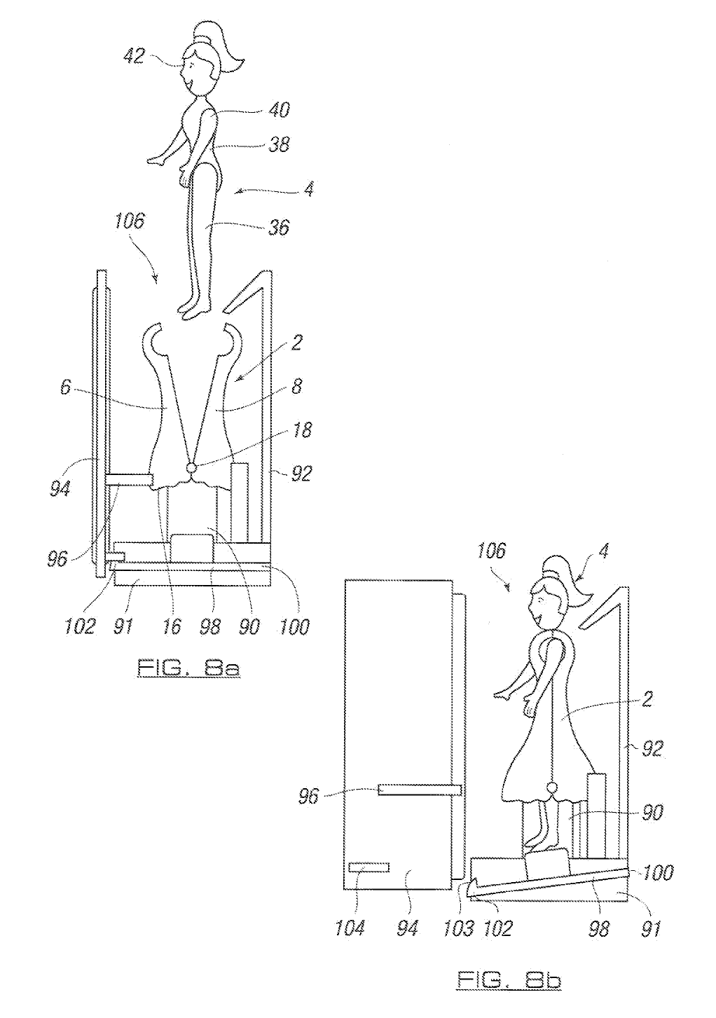

FIGS. 7a-7d show an example of a first mechanism by which the garment in FIGS. 1a and 1b could be attached to a toy doll in use;

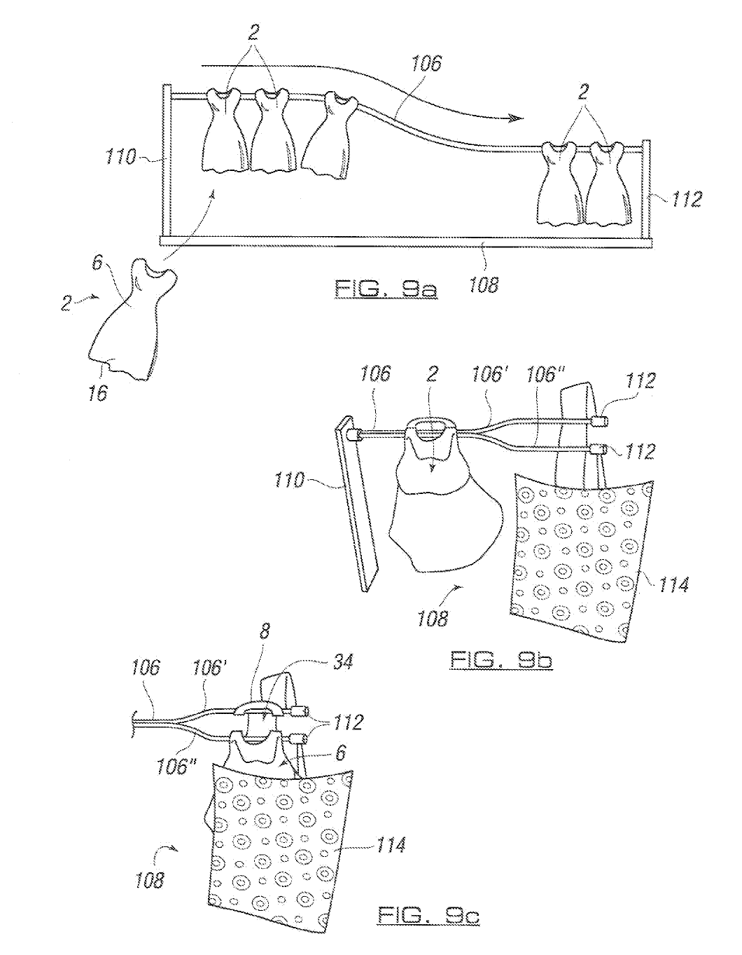

FIGS. 8a-8b show an example of a second mechanism by which the garment in FIGS. 1a and 1b could be attached to a toy doll in use;

FIGS. 9a-9c show an example of a third mechanism by which the garment in FIGS. 1a and 1b could be attached to a toy doll in use;

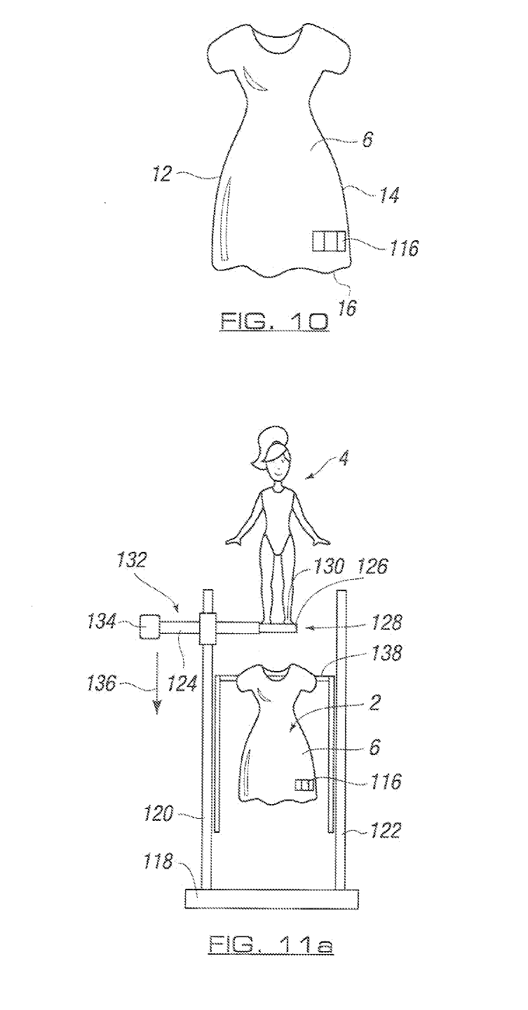

FIG. 10 shows-an example of a hinge mechanism for a garment according to a second embodiment of the present invention;

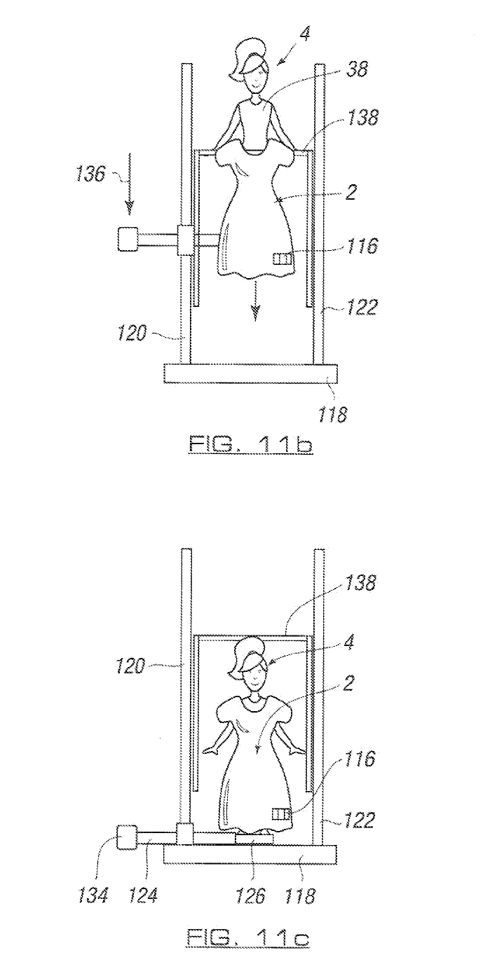

FIGS. 11a-11c show an example of a mechanism by which the garment in FIG. 10 could be attached to a toy doll in use;

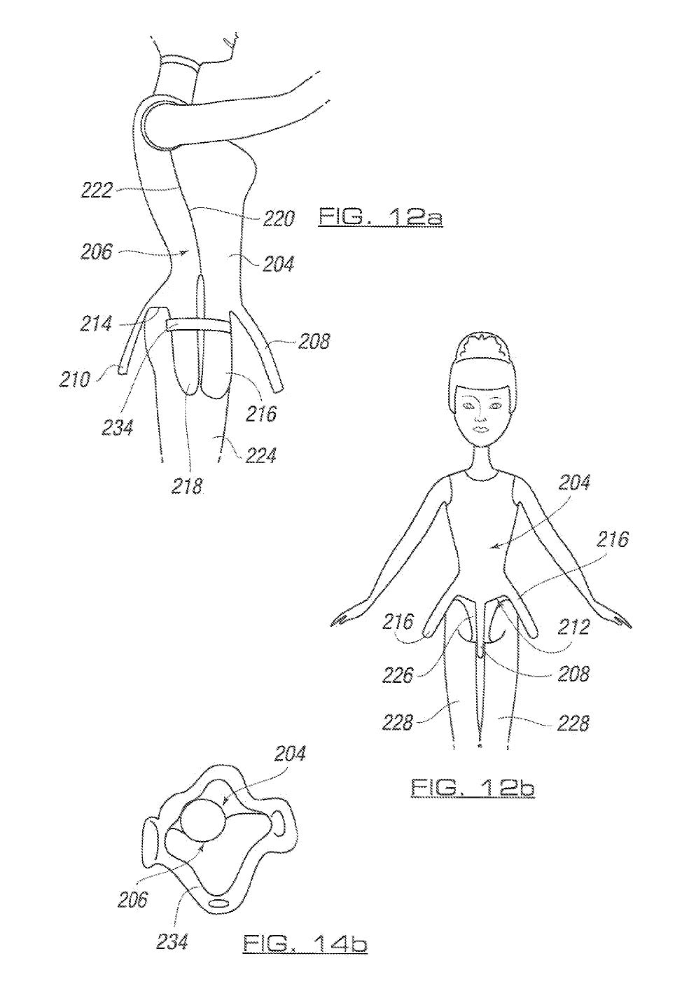

FIGS. 12a and 12b show a side view and a front view of a further embodiment of a garment according to the present invention;

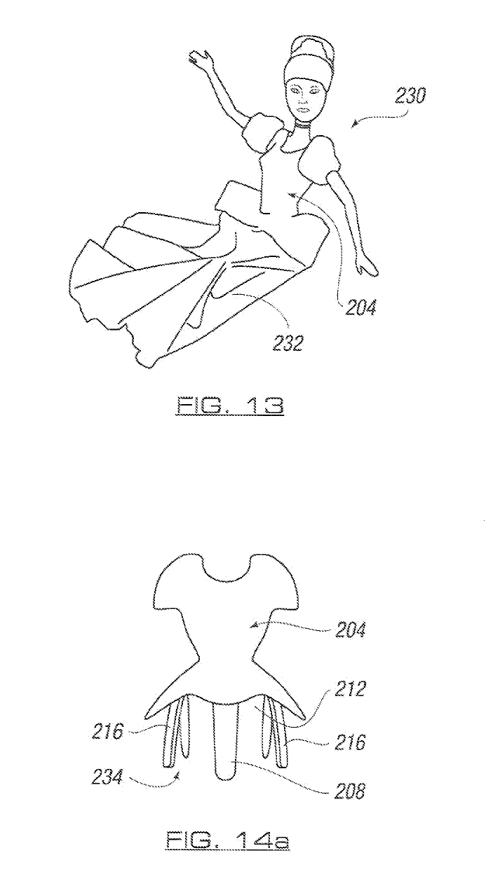

FIG. 13 shows the doll wearing the garment shown in FIGS. 12a-b in a seated position; and

FIGS. 14a and 14b show a front view and base view of a spring mechanism used in the garment shown in FIGS. 12a and 12b.

Referring firstly to FIGS. 1a-4, there is illustrated a garment 2 according to a first embodiment of the present invention that can be detachably attached to a toy doll 4.

The garment 2 in this example is in the form of a ladies dress and includes a first front part 6 and a second rear part 8. Front part 6 has a top edge or surface 10, lateral edges or surfaces 12, 14 and a base edge or surface 16. Rear part 8 has a top edge or surface 10′, lateral edges or surfaces 12′, 14′ and a base edge or surface 16′.

The front and rear parts 6, 8 are hingedly joined along the lateral edges 12, 12′, 14, 14′ thereof adjacent the base edge 16, 16′ via a hinge arrangement 18. The hinge arrangement 18 allows the front and rear parts 6, 8 to be moved between a closed position, wherein the lateral edges 12, 12′, 14, 14′ of the front and rear parts are adjacent to and in abutting relationship with each other, and an open position wherein the lateral edges 12, 12′, 14, 14′ arc separated and moved away from each other.

In the illustrated embodiment, with the parts 6, 8 in the closed position, the parts 6, 8 are substantially parallel to each other, as shown in FIG. 1a. With the parts 6, 8 in the open position, the parts 6, 8 are moved apart from each other to form an acute angle between the same, as shown in FIG. 1b.

The shape and configuration of the parts 6, 8 can be substantially the same as each other, can be mirror images of each other or can be different to each other.

An example of a hinge arrangement is shown in FIG. 2a. In this example, hinge arrangement 18 includes protrusion means in the form of a pin 20 provided adjacent each lateral edge 12′, 14′ of the rear part 8, and a sleeve member 22 with a channel 24 defined therethrough provided adjacent each lateral edge 12, 14 of the front part 6. Each pin 20 is rotatably mounted in channel 24 of sleeve member 22. Resilient biasing means in the form of a torsion spring 26 arc provided between the pin 20 and the sleeve member 22 to resiliently bias the hinge arrangement 18 to a closed position.

An example of a further hinge arrangement is shown in FIG. 2b, whereby an elastic band 28 is used in place of torsion spring 26 to bias the hinge means to a closed position. A support member 30 is provided on each part 6, 8 adjacent lateral edge 12, 12′ to allow the elastic band 28 to be joined between the same.

In order to move the garment 2 between the closed and open positions, a user grips the outer surfaces of parts 6, 8 and applies a compressive force thereto adjacent the base edges 16, 16′ thereof (i.e. squeezes the base edges 16, 16′ together), as shown by arrows 32 in FIG. 1b. If the force applied is sufficient to overcome the biasing force of spring 26 or elastic band 28, the parts 6, 8 separate along their lateral edges 12, 14, 12′ 14, and top edges 10, 10′ move away from each other. This leaves an opening 34 defined between the top edges 10, 10′ that is of sufficient size and shape through which the toy doll 4 can be located.

In the illustrations 3a-3c, toy doll 4 is in the form of a female human figurine comprising a pair of legs 36, a trunk 38, arms 40 and a head 42. The feet and legs 36 in this embodiment are inserted through the opening 34 at the top 10 of the garment when in an open position. The dress and/or doll can be slidingly moved towards each other (i.e. the legs 36 are moved through the opening of the garment and between the parts 6, 8), as shown by arrows 43 in FIG. 3a.

The garment parts 6, 8 typically define a cavity therebetween which is of sufficient size and shape to fit at least part of the doll therein in use. In particular, the shape and size of the interior surface of the garment parts 6, 8 is preferably substantially similar or slightly larger than the shape and size of the exterior surface of the doll, particularly the trunk 38 of the doll, thereby forming a snug fit when at least part of the garment is engaged to at least part of the doll. This prevents the garment from moving around too much on the doll when fitted and provides a realistic appearance of the doll wearing human clothing. In addition, once the feet of the doll are located through the opening 34, the contours of the interior surface of the parts 6, 8 and/or the top edges 10, 10′ engaging against the trunk 38 of the doll maintains the parts 6, 8 in an open position without a user being required to maintain the compressive force at the base edges of the parts, as shown in FIG. 3b. Thus, the user only has to provide an initial compressive force on first placing the doll in the opening 34, and thereafter the user can remove the compressive force and the garment will remain in an open position until the top part 10, 10′ of the garment reaches the narrower neck 44 of the doll. The garment is then automatically moved to a closed position on the doll, as shown by FIG. 3c, as a result of the biasing force of the spring 26.

A shaped recess 44, 44′ is provided adjacent the top 10, 10′ of parts 6, 8 to fit around the arms 40 of the doll when the garment is fitted on the doll. An opening is defined between the parts 6, 8 in the top edge for the neck of the doll to be located therethrough when the parts are in a closed position. An opening is also defined between the parts 6, 8 in the base edge of the legs of the doll to be located therethrough when the parts are in a closed position.

It will be appreciated by persons skilled in the art that the garment 2 could be in any suitable form and is not limited to a ladies dress. In addition, the garment 2 could be attached to an article other than a doll. For example, garment 2 could be fitted to a coat hanger 46, as shown in FIGS. 5a and 5b. The parts 6, 8 could be moved to an open position by a user, as shown in FIG. 5a and the hanger 46 could be inserted into the opening 34 defined between the two parts 6, 8 when in the open position. Once the garment is moved back to a closed position, as shown in FIG. 5b, the protruding arm portions 48 of the hanger 46 extend beyond the neck opening 50 of the dress when in the closed position, thereby securing the hanger 46 in place on the garment.

FIGS. 6a-6c illustrate the garment 2 being fitted to an article in the form of a mannequin 52. The mannequin includes a body portion 54 corresponding to the trunk of a human that is located on a stand 56 supported on a worksurface or other suitable surface in use. A head portion 58 and neck portion 60 can be joined to a top of the body portion 54. In this embodiment, rather than the base of the doll being inserted through opening 34 of the garment as illustrated in FIGS. 1-4 during manual opening of the parts 6, 8 by a user, the base 16, 16′ of the garment 2 is located over the head portion 58 of the mannequin 52 and slidingly pushed down onto the mannequin towards stand 56, as shown by arrow 62 in FIG. 6b. Engagement of the contours of the interior surface of the parts 6, 8 with the contours of the exterior surface of the mannequin 52 during this downward sliding motion causes the parts 6, 8 to move to an open position. As such, the parts 6, 8 can be moved from a closed position to an open position without a user being required to manually squeeze the base of the parts together. This is possible due to the position and orientation of the pivotal axis of the garment being located substantially transverse to the direction in which an article or toy is to be located through an opening of the garment. The article or toy is passed through the pivotal axis of the parts when located with the parts (i.e. the toy passes through the plane that is parallel to the pivotal axis of the parts).

The position of the pivot or hinge arrangement in the present invention also allows the garment to be fitted to an article or doll via a number of possible partially or wholly automated mechanisms, as shown in FIGS. 7a-9c.

In FIG. 7a, the garment 2 is slid in a downwardly direction onto a stand 64 via base 16, 16′ in a similar manner to the mannequin embodiment shown in FIGS. 6a-6c, as shown by arrows 66.

A movable platform 68 is provided adjacent the base 70 of stand 64 and the platform 68 and stand 64 arc both provided in a housing 72 having an open top 74. An actuation arm 76 is joined to movable platform 68 at a first end. 78 and an opposite end 80 of actuation arm 76 protrudes outwardly from housing 72 to form a handle 82. More particularly, the movable platform has an aperture (not shown) defined therein and stand 64 is located through the aperture and is slidingly movable along the vertical or longitudinal axis of the stand in use. A slot (not shown) is defined in the side wall of housing 72 to allow the actuation arm and handle to also be moved between raised and lowered positions with respect to the vertical or longitudinal axis of the stand in use.

The garment 2 is moved onto the stand 64 until the base 16, 16′ of the garment rests on movable platform 68. Engagement of the interior surface of the garment with the exterior surface of the stand moves the garment from a closed position, as shown in FIG. 7a, to an open position, as shown in FIG. 7b.

Engagement means 84 for the feet of a doll 4 are located at a top free end 86 of stand 64. With doll 4 engaged in engagement means 84, the doll 4 is located substantially centrally of stand 64 in an upright manner such that the doll protrudes above the top edge of housing 72.

A user can then slide handle 82, and therefore actuation arm 76, movable platform 68 and garment 2 in an upwardly direction, as shown by arrow 88 in FIG. 7c, such that the legs 36 of the doll are inserted downwardly through the top opening 34 of the garment 2. This action continues until the garment 2 engages with the doll 4 as previously described and as shown in FIG. 7d.

In FIGS. 8a-8b an alternative mechanism is shown via which a doll 4 can be dressed or brought into engagement with the garment 2. In this embodiment the garment 2 is located on a stand 90 on a base 91 of a housing 92. The housing 92 includes a pivotable door 94 provided on a side wall thereof that is movable between an open condition, as shown in FIG. 8b, and a closed condition, as shown in FIG. 8a. A lever 96 provided on the interior surface of the door 94 and protruding inwardly of the internal space within the housing 92 is arranged to engage part 6 adjacent base 16 of the garment 2 when the door is in a closed position, thereby providing sufficient compression adjacent the base 16 to move the hinge arrangement 18 of garment 2 to the open position.

A pivotable platform 98 is provided adjacent base 91 of housing 92. One end 100 of platform 98 is joined to a pivot arrangement and the opposite end 102 of platform 98 is provided with a hook 103 that is engageble with a catch 104 provided on the interior surface of door 94.

The housing 92 is an open topped housing and, in use, the legs 36 of doll 4 are moved downwardly through the housing opening 106 and into the open top of garment 2, as shown in FIG. 8a. As the feet of the doll 4 engage with platform 98, this causes the platform to pivot in a downwardly direction, thereby releasing hook 103 from door 94 and causing door 94 to move from a closed position to an open position. On opening of the door 94, lever 96 is moved Out of the engagement with garment 2 resulting in the garment moving from an open position to a closed position. As such, once the door is opened, the garment 2 is engaged to the doll 4 and provides the user with the impression that the doll has dressed itself.

In FIGS. 9a-9c a further mechanism is provided for allowing a doll to be dressed. In this embodiment a bifurcated rail 106 is supported above a platform 108 via upright support members 110, 112. The rail 106 is a single rail at end 110 and splits into two rails 106′, 106″ towards end 112. In addition, the rail 106 is optionally located a greater distance above platform 108 at end 110 than at end. 112.

A garment 2 is moved manually by a user from a closed position to an open position by compressing the garment on parts 6, 8 adjacent base 16. This causes the top 10, 10′ of the garment to open and the rail 106 can be located through the top opening 34 of the garment adjacent end 110 of rail 106. The garment is then slidingly moved on rail 106 from end 110, wherein the garment is in the closed position, towards end 112, wherein the top parts 10, 10′ of garment parts 6, 8 are moved to the open position as top part 10 of garment part 6 engages with front rail 106″ and top part 10′ of garment part 8 engages with rear rail 106′. A doll 4 can then be located downwardly through the top opening 34 of the garment as previously described. Location of the doll into the open garment can take place behind a curtain 114 or other suitable closure to provide the user with the appearance that the doll has automatically dressed itself.

The garment can slidingly move along rail 106 as a result of a user manually sliding the garment on the rail 106, via gravity as a result of end 110 of rail 106 being higher than end 112 of rail 106, or via a suitable mechanical sliding mechanism.

FIG. 10 shows the garment with an alternative hinge arrangement to that described previously. In this embodiment the hinge arrangement 116 is provided adjacent one lateral edge 14 of the dress only. This allows a lever to be passed through the opposite lateral edge 12 that does not have the hinge and between garment parts 6, 8, thereby providing a further mechanism via which the garment parts 6, 8 can be moved from a closed position to an open position. An example of such a mechanism is shown in FIGS. 11a-11c.

A frame is provided having a base 118 and two upright members 120, 122 located a spaced distance apart on base 118. A lever 124 is slidably arranged on upright member 120 to allow the lever to be moved longitudinally of upright member 120 between a raised position, as shown in FIG. 11a, to a lowered position, as shown in FIG. 11c. Lever 124 includes engagement means 126 provided at a first end 128 to which the feet. 130 of doll 4 can be engaged to position the doll in an upright manner. End 128 of lever 124 is movable between upright members 120, 122 in use. Second end 132 of lever 124 is provided with a handle element 134 to allow a user to slide the lever between the raised and lowered positions, as shown by arrow 136.

A rail 138 is provided between upright members 120, 122 a sufficient spaced distance above base 118 to allow a garment 2 to be located on rail 138 and to hang in free space below rail 138 in a closed position. The rail 138 is typically located through opening 34 of the garment 2 when clipped onto the rail in an open position as previously described.

As the lever 124, and therefore the doll 4, is moved from the raised position towards the lowered position, the lever 124 and engagement means 126 slides between the lateral edges 12, 12′ of parts 6, 8 of garment 2. The exterior contours of the doll 4 causes the garment 2 to move from a closed position to an open position, thereby releasing garment 2 from engagement with rail 138 and engaging the garment 2 to the trunk 38 of doll 4, as shown in FIG. 11c.

If all or a substantial part of the mechanism in FIGS. 11a-11c is provided within a housing or behind a curtain or other suitable closure means, it provides the user with the impression that the doll has dressed itself.

Thus, it can be seen by a person skilled in the art that by providing the garment of the present invention with a hinge arrangement between one or, more lateral edges of front and rear parts of the garment or accessory, at least part of a toy or doll can be arranged to pass through a plane that is substantially parallel and aligned with the hinge or pivot axis of the hinge arrangement and this allows a number of different arrangements to be provided via which the garment or accessory can be engaged to the doll or toy.

Referring to FIGS. 12a-14b, there is illustrated a further embodiment of a garment 202 that can be detachably attached to a doll in a similar manner to the embodiments already described.

In this embodiment the garment 202 is in the form of a ladies corset or bodice. The garment includes a front part 204 and a rear part 206. User actuation means in the form of protruding portions 208, 210 protrude outwardly and below from base edges 212, 214 of said front and rear parts 204, 206 respectively. The protruding portions 208, 210 are in the form of pinch stems and arc of sufficient size to allow a user to apply a compressive force on the portions towards each other and the doll, thereby allowing the parts 204, 206 to move from a closed position to an open position.

Extension portions 216, 218 are provided adjacent the lateral edges 220, 222 of both the front and rear parts 204, 206. The extension portions 216, 218 extend below the base edges 212, 214 of the front and rear parts 204, 206. The hinge 224 is provided at the free end of the extension portions 216, 218 to hingedly join the same together.

The dimensions and positions of the extension portions 216, 218 and protruding portions 208, 210 are such that they do not obstruct movement of the waist 226 and/or legs 228 of the doll. This allows the doll 230 to sit down, as shown in FIG. 13. In particular, protruding portions 208, 210 are sufficiently thin so that the legs 228 can be moved either side of the same. For example, the legs of the doll can move through an acute or perpendicular angle without obstruction from the clothing.

The front and rear parts 204, 206 are substantially rigid in form and substantially flexible fabric 232 can be attached to the exterior and/or interior surfaces of the parts to provide a skirt for the bodice/corset.

A single spring element 234 is provided around the perimeter of the base opening of the parts 204, 206 and around the extension portions 216, 218 to bias the parts 204, 206 from the open position to the closed position in use, thereby allowing the parts to be secured to the doll 230.

1. A detachable garment or accessory for a toy, said detachable garment or accessory comprising:
at least a first front part and a second rear part pivotably or hingedly movable relative to each other via pivot or hinge means provided on or associated with the parts between an open position, wherein the garment or accessory can be attached to or removed from at least part of the toy, and a closed position, wherein the garment or accessory can be secured to the toy, characterised in that each of the at least first front part and second rear part include a top edge, a base edge and lateral edges, said pivot or hinge means provided between one or more of the lateral edges of said front and rear parts to allow at least a portion of the lateral edges of the parts to be separated to form the open position and moved towards each other to form the closed position.

2. The detachable garment or accessory of claim 1 wherein a pivot or hinge axis of the pivot or hinge means, about which the at least first front part and the second rear part pivot, hinge or rotate in use, passes through an opening or cavity defined between the at least first front part and the second rear part.

3. The detachable garment or accessory of claim 1 wherein a pivot or hinge axis of the pivot or hinge means, about which the at least first front part and the second rear part pivot, hinge or rotate in use, is substantially transverse to the lateral edges of the at least first front part and the second rear part.

4. The detachable garment or accessory of claim 1 wherein the pivot or hinge means is associated with or provided at or between a single lateral edge of the first front part and the second rear part, or the pivot or hinge means is provided at or between two and/or opposite lateral edges of each of the first front part and the second rear part.

5. The detachable garment or accessory of claim 4 wherein where there are hinge or pivot means provided adjacent both or opposite lateral edges of the at least first and second parts, the pivot of hinge axes are substantially co-axial to each other and a space is defined between the same so that a toy can pass therebetween in use.

6. The detachable garment or accessory of claim 1 wherein resilient biasing means are provided with or associated with the pivot or hinge means for biasing the at least first front part and/or second rear part from the open position to the closed position.

7. The detachable garment or accessory of claim 1 wherein the first front part and/or at least second rear part is arranged such that a user is required to apply a compressive force directly or indirectly to an outer surface of both the first front part and the at least second rear part towards each other, or user actuation means are provided on or associated with the first front part and/or at least second rear part, in order to move the parts from a closed position to an open position in use.

8. The detachable garment or accessory of claim 1 wherein the user actuation means include one or more protruding portions which protrude outwardly from one or more surfaces or edges of the first front part and/or at least second rear part.

9. The detachable garment or accessory of claim 1 wherein the hinge or pivot means are provided on or associated with one or more extension parts which extend below or above an edge or portion of the at least first front part and the second rear part.

10. The detachable garment or accessory of claim 1 wherein at least one opening, recess and/or aperture is defined in the at least first front and/or second rear parts to allow at least part of a doll or toy to protrude therethrough when the garment or accessory is in a closed position on the doll or toy.

11. The detachable garment or accessory of claim 1 wherein the at least first and/or second parts are substantially rigid in form and/or include substantially flexible material or fabric attached thereto.

12. A detachable garment or accessory according to claim 1 wherein the garment or accessory is in the form of any or any combination of a dress, skirt, trousers, shirt, corset, bodice, tank top, jumper, blouse, coat, cardigan, jacket, scarf or armour.

13. A toy to which a detachable garment or accessory according to claim 1 is detachably attached in use.

14. A method of fitting a detachable garment or accessory to a toy, said method comprising the steps of:
pivotably or hingedly moving at least a first front part and a second rear part of the garment or accessory relative to each other via pivot or hinge means provided on or associated with the parts between an open position, wherein the garment or accessory can be attached to or removed from at least part of the toy, and a closed position, wherein the garment or accessory can be secured to the toy, characterised in that each of the at least first front part and second rear part include a top edge, a base edge and lateral edges, said pivot or hinge means provided between one or more of the lateral edges of said front and rear parts to allow at least a portion of the lateral edges of the parts to be separated to form the open position and moved towards each other to form the closed position.

15. A method according to claim 14 wherein at least part of the toy passes through an opening, aperture and/or recess defined between the at least first front part and the second rear part when in an open position and moves through or towards a virtual line corresponding to the pivot or hinge axis of rotation of the parts in order to secure the garment or accessory to the toy.

16. A method according to claim 13 wherein a user applies the garment or accessory to the toy manually or the garment or accessory is applied to the toy via a mechanical and/or automated means or device.
